(19) United States
(12) Patent Application Publication
(10) Pub. No.: US 2016/0355419 A1
(43) Pub. Date: Dec. 8, 2016

(54) METHOD AND ASSEMBLY FOR SEWAGE TREATMENT

(71) Applicant: SEA HORSE MANUFACTURING, LLC

(72) Inventor: JOHN PIERRE CHAUVIN, LYDIA, LA (US)

(21) Appl. No.: 15/175,828

(22) Filed: Jun. 7, 2016

Related U.S. Application Data
(60) Provisional application No. 62/172,561, filed on Jun. 8, 2015.
(60) Provisional application No. 62/287,585, filed on Jan. 27, 2016.

(51) Int. Cl. C02F 1/50; C02F 1/00; C02F 1/28

(52) U.S. Cl. CPC C02F 1/50; C02F 1/283; C02F 1/004; C02F 2103/008

(57) ABSTRACT

A method and assembly for treating waste water by way of a chemical/physical process of pulverizing and dewatering sewage waste on board a variety of different marine vessels. A method and assembly for treating waste water comprising pulverizing solid(s) for particle size reduction, disinfection and sterilization of harmful organisms, solid collection, dewatering solid(s) for disposal, and dechlorinating a final outfall without use of dilution in order to meet an allowable level of contaminants prior to discharge.

### CROSS REFERENCES TO RELATED APPLICATIONS

Priority of U.S. Provisional Patent Application Ser. No. 62/172,561, filed Jun. 8, 2015 and U.S. Provisional Patent Application Ser. No. 62/287,585, filed Jan. 27, 2016, incorporated herein by reference, are hereby claimed.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

Field of the Invention

The present invention pertains to a method for treating waste by way of pulverizing and dewatering sewage waste on board a variety of different marine vessels and that can function in a relatively small space-saving operational area within engine rooms, equipment rooms, or any other non-recreational, non-gathering area within said marine vessels and/or oil and gas production and drilling platforms and vessels. More particularly, the present invention pertains to a process for treating waste comprising particle size reduction, disinfection, solid collection, and dewatering. More particularly still, the present invention pertains to a method for treating waste water that is approved by the United States Coast Guard (USCG) and the International Maritime Organization (IMO) for use in United States and International waters, where any level of pollutant that is released into a marine ecosystem is generally regulated and monitored for a variety of environmental impacts.

Brief Description of the Prior Art

Generally, the two most popular Type II waste treatment methods for marine vessels that are approved by the United States Coast Guard (USCG) are the biological sewage treatment units and the physical/chemical sewage treatment units. Operators who manage the biological system generally prefer this type of unit because of the ease of operation and low maintenance that is needed to generate a desired quality of water that is sufficient for environmental discharge. However, the biological system's biggest disadvantage is that all biological units are typically very large in size and very heavy in weight compared to the chemical/physical units, which are relatively smaller in size and relatively lighter in weight.

Most conventional biological systems use some form of biodegrading bacteria, physical solid separation, and disinfection. This process requires waste to be moved through three chambers to complete its treatment before being released into the environment. The initial stage uses activated sludge that is generally enriched with biodegradable bacteria in order to reduce organic matter within its digestion chamber. From the digestion chamber, the activated sludge moves to the secondary chamber where the sludge physically separates by either settling or rising to the surface of the water. On the surface of the water, floating solids are generally collected by skimmers, which operate by utilizing air generated by the biological unit's aeration source. The solids, which settle to the bottom of this secondary chamber, are then gathered and returned using air that is generated by the biological unit's air supply. From the second chamber, clear separated water comes in contact with chlorine, thereby sanitizing an effluent stream for discharge. Generally, a chlorine contact chamber is used to give the unit a desired retention time for sufficient disinfection.

Like biological sewage treatment systems, chemical/physical sewage treatment units have a series of stages that are common to a majority of the units. These types of conventional chemical/physical units typically have a solid reducing stage, a disinfecting stage, and a dilution stage. Solid reducing would generally be achieved by pulverizing the waste as it enters the first chamber of the system. Pulverizing can be done mechanically by way of motorized chopping and shredding, or any other similar means. After the solid waste is reduced to a required size for discharge, it is then gathered into a chamber, thereby awaiting further disinfection.

Disinfection can be done in two different ways—either by applying chlorine from an outside pre-manufactured source or by generating chlorine from a seawater source for treatment. Some particular processes have electrically charged plates or rods, known as anodes, that are situated and mounted directly in the digestion chamber, or some particular processes may electrically charge alternate piping in which waste water flows through after the waste has been pulverized. Typically, this process can only be done if seawater is used to flush a number of toilets and/or lavatories. To disinfect directly, the influent waste stream and seawater flushed from lavatories would pass through a plurality of electrically charged plates within the digestion chamber, splitting a salt compound within the seawater to generate chlorine, thereby instantaneously disinfecting all biological and pathological organisms. If generating and collecting chlorine for injection is desired, then it is generally done in the same fashion, but by splitting salt compounds in a separate filtered seawater chamber, free from solids, and then pumped into the waste stream. When dilution, in combination with seawater-generated chlorine, is needed to achieve effluent discharge qualities, a consistent flow of seawater would typically be necessary in order to achieve adequate treatment for discharge under the USCG Type II specifications for these particular chemical/physical units.

Traditionally, vessel owners, operators, and captains do not like to use seawater for sanitary use in lavatories for a number of reasons. For example, the seawater that is drawn from outside a vessel almost always contains a plurality of aquatic organisms, which can gather and decay in the bowls of the lavatories, thus causing odors in the restrooms. Further, crews generally do not like using seawater while located in a port-of-call because bilge water from other vessels in its vicinity is discharged, thus concentrating in the marinas and contaminating the source of water that is needed for lavatory function. As a result, this can cause the lavatories to have unsightly oil and grease stains and residue.

Finally, when the vessels enter into international ports located at the mouth of fresh water rivers, the river water dilutes the seawater, thereby reducing the concentration of salt to a degree in which the chlorine that is produced is minimal. Thus, not having enough chlorine for these systems can cause the unit to produce an odor and perform outside of its certification parameters. As a result, crews then have to either slow the treatment process by restricting the flow of seawater or dilute the effluent more, thereby decreasing pollutant concentration. Restricting overboard seawater flow and increasing electrolysis time, allowing concentration levels of chlorine to rise relatively high enough for proper operation will restrict the influent flow and the amount of waste that the unit can treat.

In the past, chlorine has been used and released with the waste stream in order to meet the sanitizing levels that are required by a USCG approved Type II marine sanitation device; however, an amount of chlorine that has typically been used was not limited, only required—meaning, if a chemical/physical or biological treating marine sanitation device (MSD) used chlorine, the USCG only required a minimum amount of chlorine to be used, with no maximum limit of chlorine when operating in federal waters. As a result, most conventional chemical/physical units that utilize chlorine as their disinfecting source generate high levels of chlorine in order to ensure adequate sterilization of biological and pathological organisms that is required by the USCG.

Treatment units that use chlorine, or any other disinfecting chemical, in their process, depending on the amount of these chemicals, can cause the effluent-treated waste stream to have a high level of Chemical Oxygen Demand (COD). Prior to 2010, COD levels were not regulated with respect to inspected and uninspected marine vessels for USCG or International Maritime Organization (IMO) approved systems. Therefore, the IMO implemented regulations on MSD units working in waters that are governed by the IMO that require a reduction in COD levels. As a result, chlorine, being the main contributor of high COD levels, now has to be removed or neutralized in IMO governed waters.

Because of the relatively high level of chlorine used within the digestion stage of a chemical/physical unit, bacteria would not have a suitable environment for decomposition, thereby resulting in the solids not being reduced enough for discharge. Further, pulverizing the influent waste could only achieve limited levels that are generally not sufficient enough for discharge. To compensate for these deficiencies, these conventional units would typically use dilution. Dilution is used for the purpose of reducing the concentration amounts of contaminants per gallon of treated discharge. Without the use of dilution, the vast majority of conventional chemical/physical units would not be able to meet the parameters set by the USCG Type II sanitation devices for discharge into navigable waters. Thus, diluting effluent waste streams with filtered seawater or freshwater would increase the water to particulates ratio, therefore allowing the unit to meet its regulatory limit for Total Suspended Solid (TSS) discharge.

However, dilution rates are now regulated and must be factored into a level of contaminates that are allowed in discharge(s) coming from USCG/IMO sewage treatment systems. As an amount of dilution increases, the regulated discharge contaminant concentration limits decrease. Non-diluted discharge streams typically have the most liberal limits for effluent discharge. The more dilution that is introduced into the discharge, the more conservative the pollutant limits can become. When units are approved for USCG/IMO operations, their certificate or approval number will illustrate a dilution factor, which must be calculated for allowed discharge contaminant levels.

Conventional chemical/physical units have traditionally processed sewage waste by pulverizing solid(s) then, through electrolysis of seawater, creating a relatively high dose of chlorine used to completely bleach and sanitize the waste stream. Dilution of freshwater or seawater would then be added in relatively large amounts to finalize the treatment process, thereby lowering pollutant concentration, but raising an amount of discharge flow. These conventional Type II USCG approved units are generally located on, but not limited to, ships, tow boats, oil field work boats, ferries, and occasional oil rig and production platforms in working waters throughout the world. On these vessels and platforms, seawater is generally used to flush lavatories, thus eliminating the use of a vessel or platform's supply of fresh water, which is an advantage due to fresh water being relatively expensive to self-generate on board these vessels and remote living accommodations.

These past techniques of treating sewage waste streams using chemical/physical USCG Approved Type II units are being phased out because the aforementioned techniques cannot produce a discharge outfall set by IMO regulations, without the use of dilution. As a result, the USCG is currently in the process of adopting the IMO requirements for discharge, which will require removing chlorine and factoring in the dilution ratio for discharge parameter limits. The more dilution the process requires to meet the discharge limits for the pollutant parameters, the larger the numerical factor will be to calculate its USCG/IMO certification level. As the amount of water required for dilution increases for effluent quality, the calculating factor will change, thus decreasing the allowed amount of pollutant concentration per part of waste water. The numerical factor will be illustrated on the certificates issued by the USCG agency.

### SUMMARY OF THE INVENTION

The present invention comprises a method and assembly for treating waste water by way of a chemical/physical process for sewage treatment for use in pulverizing and dewatering sewage waste on board a variety of different marine vessels. The method of the present invention treats sewage waste by pulverizing solid(s), sterilizing harmful organisms, dewatering solid(s) for disposal, and dechlorinating the final outfall without the use of dilution to meet an allowable level of contaminants before discharge. In order to accomplish an adequate treatment process for discharge, the method of the present invention can move untreated sewage at a rate that is relatively slow enough and under a substantially high enough pressure to give the untreated waste time to be disinfected and channeled with sufficient pressure, thereby removing the solids from an incoming waste stream before discharge.

The purpose of pulverizing the influent sewage waste is to minimize the size of any solids within the incoming waste stream. After the solids are processed within a digestion chamber, said solids are then pumped through a linked series of mixing pipes, herein referred to as a “worm.” Within said worm, the pulverized waste stream and a disinfecting chlorine solution is mixed for a desired amount of time that is necessary for elimination of harmful biological and viral organisms. By way of illustration, but not limitation, the chlorine that is needed for the process can either be added by a premanufactured outside source (such as, for example, a tablet or a solution) or self-generated from overboard seawater by way of direct current (DC) volt electrolysis, or any other similar means.

In a preferred embodiment, the method of the present invention comprises a blackwater and/or a greywater flow path. Said blackwater and/or greywater flow path comprises influent entering an inlet and flowing into a maceration chamber. The influent is then macerated and simultaneously drawn into a dual-barrel hydraulic filter press piston pump. Said piston pump pushes the influent into a mixing worm, where said influent is then mixed with a liquid disinfection stream.

The method of the present invention further comprises a seawater flow path. Said seawater flow path comprises seawater entering through a seawater inlet, wherein, by way of illustration, but not limitation, a typical pressure of approximately 40-60 pounds per square inch (psi) is generally required. Seawater then flows through a course filter screen in order to remove relatively large particulates. Then, said seawater flows through a flowswitch in order to indicate that there is seawater flow, and thus, allow for wash down and a chlorinator to be incorporated. This seawater then flows through an electrical actuator switch, which is beneficially activated after said maceration chamber is emptied. Flow is then split into at least two paths: flow that is used to wash down the system and flow that travels to the chlorinator. The flow that is used to wash down the system uses the pressurized seawater to clean the maceration chamber after each maceration cycle. The flow that travels to the chlorinator fills the chlorinator with seawater after each wash down cycle, whereby there is an approximately thirty (30 sec.) second dwell time in said chlorinator in order to produce approximately 5 to 10 parts per million (ppm) chlorine.

Further, the method of the present invention comprises a combined flow path, wherein chlorine-enriched seawater that is self-generated by electrolysis, is mixed with macerated blackwater and/or greywater in said mixing worm during a filter press cycle. This mixed flow can now enter a filter intake manifold. The mixed flow then passes through a filter bank. The filter bank comprises filter bags that are designed and constructed to separate the solids from the water as well as removing most of the chlorine. The filter bags are designed and constructed with a parable material that is layered by activated carbon. Once passed from the filter banks, for additional dechlorination, the waste stream then flows through an exit manifold and de-chlorination chamber. As a result, the filtered effluent is then released out into the sea.

In a preferred embodiment, the filter press pump assembly is designed to move untreated, slightly acidic sewage waste water and heavily chlorinated corrosive water that is generated from sea water with each pump stroke. The filter press pump assembly can move chlorine concentrated liquid and solid concentrated sewage waste water at a relatively slow rate, under a relatively high pressure, with said pressure being approximately high enough to move these two streams through a plurality of filters for the desired removal of any solid(s).

In a preferred embodiment, the filter press pump assembly comprises a hydraulic power source, which can move a piston, thereby causing a suction that is needed in order to draw a desired stream of water, and thus, creating an amount of pressure that is necessary in order to move said water through a filter bank. The filter bank has an initial breakthrough pressure of approximately twenty (20) lbs., which means that water will not start flowing through said filters until the pump pressure reaches at least 20 lbs.

The sewage treatment assembly and the method of treating waste water of the present invention has been developed in order to treat sewage waste water without having a dilution factor, a chlorine residual level, and an acceptable total suspended solid level and chemical oxygen demand in its treated effluent. The stages and component parts of the waste treatment unit of the present invention can be disassembled from its frame and then be remotely mounted and reassembled within a desired area of a vessel, without disruption of the waste water treatment process. Further, the waste water treatment process and system does not require seawater for the channeling of waste and flushing of lavatories in order to operate properly; seawater is only needed in order to generate chlorine for use in the process of the present invention. As a result, the present invention can achieve regulated discharge levels, and thus, is a USCG/IMO approved chemical/physical Type II sewage treatment unit.

### BRIEF DESCRIPTION OF THE DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a front perspective view of a preferred embodiment of a waste treatment assembly of the present invention mounted on a frame.

FIG. 2 depicts a rear perspective view of a preferred embodiment of a waste treatment assembly of the present invention mounted on a frame.

FIG. 3 depicts a rear perspective view of a preferred embodiment of a waste treatment assembly of the present invention.

FIG. 4 depicts a front perspective view of a preferred embodiment of a digestion chamber, a maceration pump, and a recirculation line of a waste treatment assembly of the present invention.

FIG. 5 depicts a front perspective view of a preferred embodiment of a self-generating chlorination cell of a waste treatment assembly of the present invention.

FIG. 6 depicts a rear perspective view of a preferred embodiment of a self-generating chlorination cell of a waste treatment assembly of the present invention.

FIG. 7 depicts a perspective view of a preferred embodiment of a plurality of filtration canisters of a waste treatment assembly of the present invention.

### DETAILED DESCRIPTION OF A PREFERRED EMBODIMENT

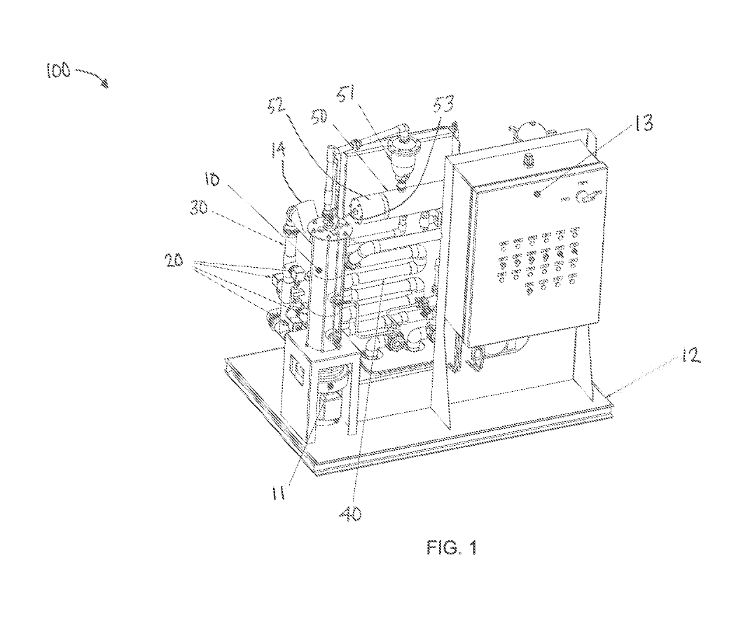

Referring to the drawings, FIG. 1 depicts a front perspective view of a waste treatment assembly unit 100 of the present invention, generally comprising a digestion chamber 10, a chlorination assembly 50, and a maceration pump 11 attachably mounted to a frame member 12. In a preferred embodiment, the method of the present invention comprises entering of waste through a waste inlet 14 and then reducing particulate size as the first part of the process, wherein reduction is done in a digestion chamber 10. Waste inlet 14 is attachably connected to digestion chamber 10, wherein digestion chamber 10 comprises a substantially cylindrical tube that is beneficially mounted above and attachably connected to a macerating device, or pump 11.

In order to reduce particulate sizes within digestion chamber 10, mechanical pulverizing device, or macerating pump 11, is utilized. When a waste level within digestion chamber 10 reaches a desired depth, a plurality of electrical sensors 20 send a signal to an automated control panel 13, thereby starting macerating pump 11. Macerating pump 11 beneficially grinds and macerates an influent waste solid(s) into a relatively small suspended size, thus allowing said influent waste solid to ultimately be recoverable in a relatively easy manner by way of filtration. Further, digestion chamber 10 is mounted above macerating device 11, where waste water is able to be channeled directly through macerator 11.

Waste is then repeatedly cycled through macerator 11 by way of a recirculation line 30 until the level within digestion chamber 10 is emptied. Recirculation line 30 comprises a series of tubing, wherein a first end of recirculation line 30 is connected at a top end of digestion chamber 10 and a second end of recirculation line 30 is connected at a top end of macerating pump 11, thus allowing waste to rotate through digestion chamber 10 and macerating pump 11.

After solid maceration, the waste stream is then sent to a series of redirected piping, known as a “worm” 40. Worm 40 comprises a plurality of cylindrical tubes that allow the waste stream to flow in a relatively back and forth direction and through the series of piping. Further, self-generating chlorination chamber 50 is attachably connected to worm member 40, wherein chlorination chamber 50 comprises a cylindrical tube for use in generating a desired amount of chlorine that is necessary in order to treat waste. Chlorination chamber 50 comprises a plurality of probes (such as, for example, an anode and a cathode) that connect within cylinder; however, probes should not remain exposed, therefore chamber comprises a cap 52 that is designed to cover probes, thus having a single wire 53 extend from cap 52 of chlorination chamber 50 to control panel box 13.

In this stage of treatment, the waste stream is disinfected with relatively high doses of chlorine, wherein said chlorine can be generated from seawater via chlorination chamber 50. Worm 40 is designed to retain the waste and channel it at a rate that is relatively slow enough for adequate retention disinfection time. Additionally, chlorine generally has to be in contact with the waste for a desired period of time in order to ensure proper disinfection and a desired organism death rate. As a result, the method of the present invention comprises an ability to move water through various stages of the unit 100 at a relatively slow enough pace to reach a highest degree of disinfection under enough flow pressure for maximum filtration.

With an amount of sea water that is generally required, where salinity levels can be as high as thirty-five percent (35%) in solution, corrosion-resistant materials are necessary for the life of waste treatment assembly 100 because of the salinity present and the chlorine that is generated. Seawater is an initial source for the chlorine that is generated by the unit 100. The chlorine is separated out of the sodium chloride compound by electrolysis. Within a corrosion resistant cell of the chlorine generator 50, seawater is collected, where a plurality of electrically charged probes are powered, thereby creating a positive and a negative polarized current. The electrical supply is direct current (DC).

The chlorination cell 50 fills with filtered seawater by way of an externally driven on-board pump that supplies waste treatment assembly 100. The unit 100 cannot draw from its own seawater, so the vessel or unit 100 must draw and channel seawater from outside waters or from an external brine solution tank. Chlorine-generating cell 50 is emptied repetitively with each run cycle and is automatically filled with seawater for the next run cycle. Seawater can either be supplied by an on-board seawater pump, an independent pump located on or near unit 100, or by a sea chest. Electrolysis then occurs within chlorination cell 50, thus preparing the solution for another dose of chlorine. Additionally, as illustrated in FIG. 1, automatic feeder/shut-off 51 is mounted above chlorination chamber 50 in a relatively perpendicular position and comprises a float valve located within an inner cavity of feeder 51. A float ball valve (although not depicted in FIG. 1) is used to fill and maintain a desired level of seawater within chlorine-generating cell 50.

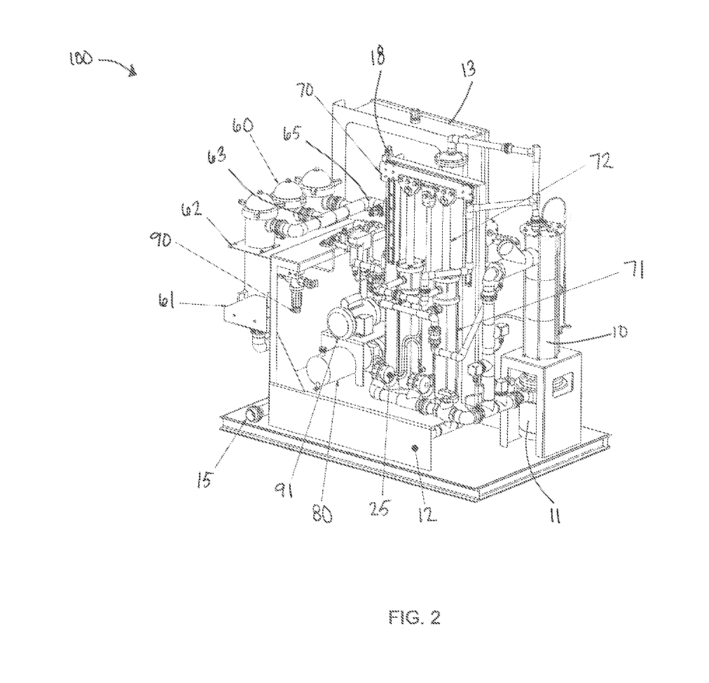

FIG. 2 depicts a rear perspective view of waste treatment assembly 100 of the present invention generally comprising a plunger pump 70 and a plurality of filtration canisters 60 attachably mounted to frame member 12. The method of the present invention comprises plunger pump assembly 70 that is designed to move fluids throughout a top location and a bottom location of a piston with each stroke of a plunger 72. Plunger pump assembly 70 comprises pump barrel 71, wherein pump barrel 71 comprises a substantially cylindrical tube having an inner cavity. Inner cavity of pump barrel 71 allows plunger 72 to be received within pump barrel 71, thereby pushing waste stream through plunger pump assembly 70, and ultimately through remaining components and stages of waste treatment assembly 100. Due to a relatively harsh nature of contaminants, seawater, and chemicals within the unit, plunger pump 70 can be manufactured from a substantially corrosive-resistant, high molecular plastic material, or any other material exhibiting like characteristics.

By way of illustration, but not limitation, a power source for plunger pump 70 comprises a self-contained, two-way actuating hydraulic pump, motor, and reservoir tank, or pump/tank assembly 80. When plunger 72 is set into linear motion, thus reaching its stroke length, plunger 72 closes a limit switch 18, thereby sending a signal at the end of each stroke to control panel box 13. The signal initiates a response from panel box 13 to reverse hydraulic power, thus causing the motion of a hydraulic ram shaft to move in an opposite direction. The pump action of plunger 72 continues in a relatively up and down motion until digestion chamber 10 is cleared of waste water. This linear motion by plunger 72, moving within pump barrel 71, creates a negative displacement, or suction, on one side of piston and a positive displacement, or push, on the other side of piston. As a result, pump assembly 70 can then move at least two different fluids to and from pump 70 with each stroke.

In an alternative embodiment, the present invention comprises a positive displacement pump (such as, for example, but not limited to, Waukesha Cherry-Burrell® SPX Flow Models U06, U15, U18, & U30) wherein positive displacement pump allows for a relatively larger amount of water to be pushed through waste treatment system 100 of the present invention. Positive displacement pump generally comprises a motor, a gear box, and a pump head. Gear motor of positive displacement pump powers, and thus pushes, positive displacement pump, thereby allowing positive displacement pump to have a relatively increased amount of pressure and a relatively slower flow rate. Positive displacement pump comprises a relatively larger cavity within said pump, thereby allowing for a relatively larger amount of water or fluid to flow through waste treatment unit 100, thus slowing a rotation for drawing in water or fluid, and ultimately, increasing pressure throughout unit 100.

Additionally, in an alternate embodiment, the present invention generally comprises a plurality of positive displacement pumps—typically two (2) pumps. One pump head can move a waste stream, and another pump can move a chlorine stream. Moreover, control panel box 13 can be adjusted to add an additional pump, as necessary.

In a preferred embodiment, a series of check valves 25 are then able to direct the fluid(s) in one direction through the unit. The fluid streams that are moving through pump comprise the pulverized waste water and a chlorine solution that is generated by seawater. After the incoming waste is pulverized and chlorine is generated, both streams combine within “worm” 40 mixing section of the process, respectfully, and at a relatively even rate (although not illustrated in FIG. 2). As a result, the function of plunger pump assembly 70 is to move at least two waste streams at a relatively low flow rate under a relatively high pressure evenly through the process in order for desired disinfection of harmful organisms and for removal of suspended particulates and inorganic chemical contaminants.

Once the disinfecting chlorine solution and influent waste stream have combined, the process of filtration, or solid removal, then occurs before discharge. Waste stream and chlorine solution flow through intake filter 65 into a plurality of filtration canisters 60, wherein filtration is typically achieved. Filtration canisters 60 comprise a substantially cylindrical tube, wherein a plurality of preamble filter bags are received within inner cavity of filtration canisters 60 (although not illustrated in FIG. 2). Additionally, a filtration frame 62 provides for a means of holding and supporting filtration canisters 60 in place during operation of waste treatment assembly 100.

In operation, solids are physically separated from the water by moving the waste stream under pressure through preamble bag filters that are located within filtration canisters 60. Particle removing bag filters are impregnated with activated carbon, wherein activated carbon removes inorganic chemicals by attracting charged elements ionically. Because the attraction is strong enough to hold the unwanted chemicals indefinitely, the particle filter bags can be disposed of safely once they are used. A plurality of pressure sensors 63 alert control panel box 13 that filter bags need to be replaced or that the elements need to be replaced immediately, and thus an audible and/or visible alarm can be given by panel box 13 when filter bags need to be replaced.

In order to replace filter bags, isolation valve 67 provides for a means to shut off fluid flow to intake filter 65, thereby stopping fluid from flowing into filtration canisters 60, and ultimately, the remaining components of waste treatment assembly 100. Further, air-purging valve 69 provides for a means to push any remaining waste water or fluid out of filter bags, thus leaving only solid waste within filter bags, thereby allowing for filter bags to be easily removed and replaced.

In an alternate embodiment, by way of illustration, but not limitation, alternate forms or methods of filtration may be used, such as, for example, material filtration, solid particulate filtration, or centrifugal filtration and separation.

After a treatment cycle has been completed, a wash down pressure pump 91 is activated by control panel box 13. Wash down pressure pump 91 comprises an inlet filter 90 for seawater, thereby allowing for a means for seawater to flow into waste treatment assembly 100, thus assisting in removing waste residue from the walls of digestion chamber 10. Effluent connection 15 is then connected to declorination chamber 81, thus providing an outlet for the filtered water to flow out of the waste treatment assembly 100. The wash down function is automatically performed, thereby removing waste residue from the walls of digestion chamber 10, thereby preparing digestion chamber 10 and waste treatment unit 100 for another waste treatment cycle.

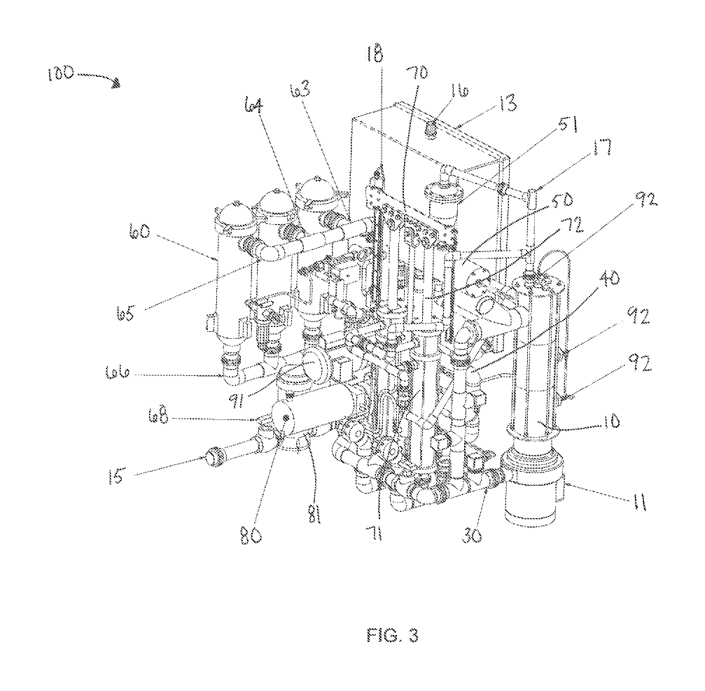

FIG. 3 depicts a rear perspective view of waste treatment assembly 100 of the present invention removed from frame member 12. Waste treatment system 100 comprises waste inlet 14 that is attachably connected to and leads to digestion chamber 10, wherein digestion chamber 10 is mountably connected to maceration pump 11. Maceration pump 11 beneficially grinds and macerates influent waste solid(s) into a relatively small size in order to allow said influent waste solid to be recoverable in a relatively easy manner by way of filtration. Recirculation line 30 comprises a series of tubing, wherein a first end of recirculation line 30 is connected at a top end of digestion chamber 10 and a second end of recirculation line 30 is connected to a top end of macerating pump 11. As a result, waste can be repeatedly cycled through macerator 11 via recirculation line 30 until digestion chamber 10 is emptied.

Still referring to FIG. 3, waste stream then flows into and through worm member 40. Worm member 40 comprises a series of redirected piping, thereby allowing waste to flow in a back and forth direction, thus channeling said waste at a rate that is relatively slow enough for adequate retention disinfection time. As this occurs, chlorine is dispersed through worm 40 by way of chlorination chamber 50 in order for chlorine to be in contact with waste for a desired period of time. Chlorination chamber 50 comprises a cylindrical tube that is attachably connected to worm member 40 in order to dispense chlorine into worm member 40.

Waste stream then flows into and through plunger pump assembly 70 that is designed to move fluids throughout a top location and a bottom location of a piston with each stroke of plunger 72. Plunger pump assembly 70 comprises plunger piston 72 and pump barrel 71 that are powered by way of a hydraulic pump assembly 80. Pump/tank assembly 80 comprises a self-contained, two-way actuating hydraulic pump, motor, and reservoir tank that enable plunger pump assembly 70 to move in a relatively linear motion, thus moving fluids (such as, for example, pulverized waste water and a chlorine solution that is generated by seawater) throughout pump 70, and ultimately, throughout waste treatment assembly 100.

In a preferred embodiment, still referring to FIG. 3, the process of filtration, or solid removal, is then able to occur before discharge. Waste stream and chlorine solution flow through intake filter 65 into filtration canisters 60, where any solid(s) are physically separated from water by moving the waste stream under pressure through a plurality of filter bags that are located within filtration canisters 60 (although not depicted in FIG. 3). Pressure sensors 63 that are located along intake filter 65 are able to detect when filter bags need to be replaced. Filtration canisters 60 then allow any excess water to flow through outlet filter 66 and into declorination chamber 81.

Declorination chamber 81 comprises a substantially cylindrical tank for use in removing any remaining chlorine from the filtered water stream; however, in an alternate embodiment, by way of illustration, but not limitation, alternate methods of declorination can also be used. Additionally, wash down pressure pump 91 is activated after a treatment cycle has been completed, wherein wash down pump 91 comprises an inlet filter 90 for seawater, thereby allowing seawater to flow into waste treatment assembly 100, thus assisting in removing waste residue from the walls of digestion chamber 10. Effluent connection 15 is then connected to declorination chamber 81, thus providing an outlet for the filtered water to flow out of waste treatment assembly 100.

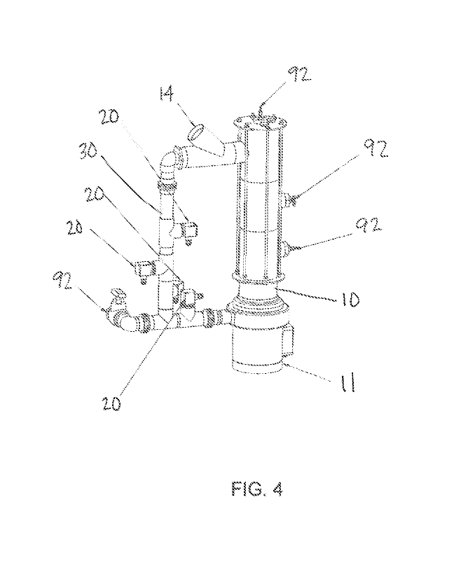

FIG. 4 depicts a side view of digestion chamber 10, maceration pump 11, and recirculation line 30 of the present invention. Waste treatment system 100 of the present invention comprises waste inlet 14, wherein waste inlet 14 is attachably connected to digestion chamber 10. Digestion chamber 10 comprises a substantially cylindrical tube member that is attachably mounted above maceration pump 11, wherein maceration pump 11 is utilized in order to reduce particulate sizes within digestion chamber 10.

When a waste level within digestion chamber 10 reaches a desired depth, a plurality of electrical sensors 20 send a signal to an automated control panel 13, thereby starting macerating pump 11. Macerating pump 11 beneficially grinds and macerates an influent waste solid(s) into a relatively small suspended size, thus allowing said influent waste solid to be recoverable in a relatively easy manner by filtration at a later stage within waste treatment system 100.

Further, still referring to FIG. 4, digestion chamber 10 is mounted above macerating device 11, where waste water is channeled directly through macerator 11. Waste is then repeatedly cycled through macerator 11 by way of a recirculation line 30 until the level within digestion chamber 10 is emptied. Recirculation line 30 comprises a series of tubing, wherein a first end of recirculation line 30 is connected at a top end of digestion chamber 10 and a second end of recirculation line 30 is connected at a top end of macerating pump 11, thus allowing waste to rotate and recycle through digestion chamber 10 and macerating pump 11.

Additionally, in a preferred embodiment, digestion chamber 10 comprises a plurality of pressure tips 92 for use in washing down inner walls within digestion chamber 10 after a treatment cycle has been completed. Pressure tips 92 allow fresh seawater to flow within digestion chamber 10, thereby removing any waste residue from inner walls of digestion chamber 10.

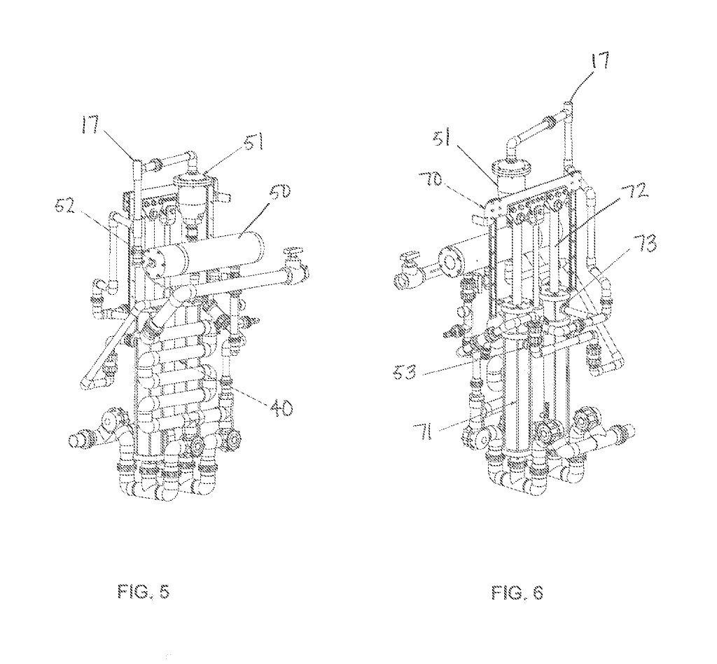

FIG. 5 depicts a front perspective view of worm member 40, chlorination chamber 50, and automatic feeder 51 of the present invention. Waste treatment system 100 comprises worm member 40, wherein worm 40 comprises a series of redirected piping that is designed to retain the waste and channel it at a rate that is relatively slow enough for adequate retention disinfection time. Chlorination chamber 50 is attachably connected to worm member via a chlorination line, wherein chlorine is dispersed and released back into the unit. Waste stream is then disinfected with relatively high doses of chlorine, wherein chlorine can be generated from seawater via chlorination chamber 50, and thus, seawater is an initial source for the chlorine that is generated by the unit 100.

In generating chlorine via seawater, chlorine is separated out of the sodium chloride compound by electrolysis. Within a corrosion resistant cell of chlorine generator 50, seawater is collected, where a plurality of electrically charged probes (such as, for example, an anode and a cathode) are powered, thereby creating a positive and a negative polarized current. The electrical supply is direct current (DC).

Chlorination cell 50 fills with filtered seawater by way of an externally driven on-board pump that supplies waste treatment assembly 100. The unit 100 cannot draw from its own seawater, so the vessel must channel it from outside waters or from an external brine solution tank. The chlorine-generating cell 50 is emptied with each run cycle and is automatically filled. Seawater is supplied by an on-board seawater pump, a self-contained pump located on the unit or by a sea chest. Electrolysis then occurs within the cell 50, thus preparing the solution for another dose of chlorine.

Chlorination chamber 50 comprises cap member 52 that is designed to cover electrically charged probes, thus having a single wire extend from cap member 52 of chlorination chamber 50 to control panel box 13. Additionally, as illustrated in FIG. 5, automatic feeder/shut-off 51 is mounted above chlorination chamber 50 in a relatively perpendicular position and comprises a float valve located within an inner cavity of feeder 51. Float ball valve is used to fill and maintain a desired level of seawater within chlorine-generating chamber 50.

FIG. 6 depicts a rear perspective view of plunger pump assembly 70 of the present invention. Plunger pump assembly 70 is designed to move fluids throughout a top location and a bottom location of a piston with each stroke of plunger 72. Plunger pump assembly 70 comprises pump barrel 71, wherein pump barrel 71 comprises a substantially cylindrical tube having an inner cavity. Inner cavity of pump barrel 71 allows plunger 72 to be received within pump barrel 71, thereby pushing the waste stream through plunger pump assembly 70, and ultimately through remaining components of waste treatment assembly 100.

By way of illustration, but not limitation, a power source for plunger pump assembly 70 comprises a self-contained, two-way actuating hydraulic pump, motor, and reservoir tank, or pump/tank assembly 80. When plunger 72 is set into linear motion, thus reaching its stroke length, plunger 72 closes limit switch 18, thereby sending a signal at the end of each stroke to control panel box 13. The signal initiates a response from panel box 13 to reverse hydraulic power, thereby causing the motion of a hydraulic ram shaft to move in an opposite direction. The pump action of plunger 72 continues in a relatively up and down motion until digestion chamber 10 is cleared of waste water. This linear motion by plunger 72, moving within pump barrel 71, creates a negative displacement, or suction, on one side of piston and a positive displacement, or push, on the other side of piston. As a result, pump assembly 70 can then move at least two different fluids to and from pump 71 with each stroke.

A series of check valves 25 are then able to direct the fluid(s) in one direction through waste treatment system 100. The fluid streams that are moving through pump assembly 70 comprise the pulverized waste water and a chlorine solution that is generated by seawater. After the incoming waste is pulverized and chlorine is generated, both streams combine within “worm” 40 mixing section of the process, respectfully, and at a relatively even rate. As a result, the function of plunger pump assembly 70 is to move at least two waste streams at a relatively low flow rate under a relatively high pressure evenly through the process in order for desired disinfection of harmful organisms and for removal of suspended particulates and inorganic chemical contaminants.

Additionally, as depicted in FIG. 6, pump assembly 70 comprises a leak reservoir 73. Leak reservoir 73 is located at a top end of pump barrel 71 and comprises an inner cavity for use in collecting any waste water leakage from pump assembly 70. If waste water does not leak from pump assembly 70, leak reservoir 73 will only comprise air, thus remaining in isolation from the pump assembly 70 of the waste treatment unit 100. If any waste water does leak from pump assembly 70, leak reservoir 73 will collect any excess fluid from pump assembly 70, and then be able to recycle said excess fluid back to digestion chamber 10 by way of vent line 17. As a result, excess fluid from pump assembly 70 will be able to reenter a treatment cycle and begin the process of filtration from the beginning through digestion chamber 10.

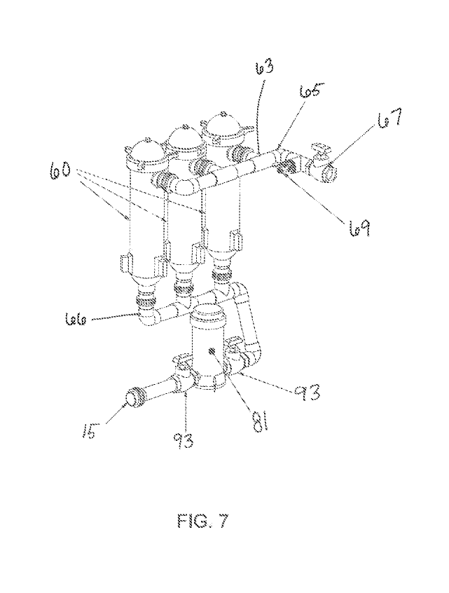

FIG. 7 depicts a perspective view of filtration canisters 60 of the present invention. Intake filter 65 directs waste stream to filtration canisters 60, wherein waste stream is then filtered through preamble filter bags within filtration canisters 60 (although not illustrated in FIG. 7). After waste stream has been successfully filtered within filtration canisters 60, waste flows through outlet filter 66 and then through declorination chamber 81, and ultimately through effluent connection 15 and out of waste treatment assembly unit 100.

In operation, once the disinfecting chlorine solution and influent waste stream have combined, the process of filtration, or solid removal, then occurs before discharge. Waste stream and chlorine solution flow through intake filter 65 into filtration canisters 60, wherein filtration is typically achieved. Filtration canisters 60 comprise a substantially cylindrical tube, wherein a plurality of preamble filter bags are received within inner cavity of filtration canisters 60 (although not illustrated in FIG. 7). Additionally, although not depicted in FIG. 7, a filtration frame 62 provides for a means of holding and supporting filtration canisters 60 in place during operation of waste treatment assembly 100.

Solids are physically separated from the water by moving the waste stream under pressure through a plurality of preamble bag filters that are located within filtration canisters 60. Particle removing bag filters are generally impregnated with activated carbon, wherein activated carbon removes inorganic chemicals by attracting charged elements ionically. Because the attraction is strong enough to hold the unwanted chemicals indefinitely, the particle filter bags can be disposed of safely once they are used. A plurality of pressure sensors 63 alert control panel box 13 that filter bags need to be replaced or that the elements need to be replaced immediately, and an audible and/or visible alarm can be given by panel box 13 when filter bags need to be replaced.

In order to replace filter bags, isolation valve 67 provides for a means to shut off fluid flow to intake filter 65, thereby stopping fluid from flowing into filtration canisters 60, and ultimately, the remaining components of waste treatment assembly 100. Further, air-purging valve 69 provides for a means to push any remaining waste water or fluid out of filter bags, thus leaving only solid waste within filter bags, thereby allowing for filter bags to be easily removed and replaced.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

1. A method for treating a waste-filled fluid comprising:
a) introducing said waste-filled fluid into a sewage treatment assembly, wherein said sewage treatment assembly comprises:
(i) an enclosure defining an inner chamber, a fluid inlet extending into said enclosure and a fluid outlet extending out of said enclosure;
(ii) a series of interconnected piping disposed within said chamber, wherein said piping defines a fluid flow path from said inlet to said outlet; and
b) circulating said waste-filled fluid through said fluid flow path.

2. The method of claim 1, further comprising pulverizing a solid(s) within said waste-filled fluid.

3. The method of claim 2, further comprising disinfecting and sterilizing any harmful organism(s) within said solids.

4. The method of claim 3, wherein said solids are disinfected by way of chlorination.

5. The method of claim 3, further comprising filtering and dewatering said sterilized solids from said waste-filled fluid.

6. The method of claim 5, wherein said sterilized solids are removed and disposed from said waste treatment assembly.

7. The method of claim 6, wherein a disinfected fluid that remains after said solids are filtered out of said waste water is then dechlorinated.

8. A sewage treatment assembly comprising:
a) an enclosure defining an inner chamber, a fluid inlet extending into said enclosure and a fluid outlet extending out of said enclosure;
b) a series of interconnected piping disposed within said chamber, wherein said piping defines a fluid flow path from said inlet to said outlet

9. The sewage treatment assembly of claim 8, further comprising a maceration pump, wherein said fluid inlet extends into said maceration pump and said maceration pump is disposed within said series of interconnected piping.

10. The sewage treatment assembly of claim 9, further comprising a chlorination chamber disposed within said series of interconnected piping.

11. The sewage treatment assembly of claim 10, wherein said chlorination chamber generates a chlorine solution from seawater.

12. The sewage treatment assembly of claim 10, wherein said chlorination chamber distributes a pre-manufactured chlorine solution.

13. The sewage treatment assembly of claim 10, further comprising a filtration system operationally disposed within said interconnected piping.

14. The sewage treatment assembly of claim 13, further comprising a dechlorination chamber disposed within said interconnected piping and operationally attached to said fluid outlet.

15. The sewage treatment assembly of claim 14, further comprising a power source.

16. The sewage treatment assembly of claim 15, wherein said power source is a hydraulic pump.

17. The sewage treatment assembly of claim 15, wherein said power source is a positive displacement pump.
